(19) United States
(12) Patent Application Publication
(10) Pub. No.: US 2011/0255057 A1
(43) Pub. Date: Oct. 20, 2011

(54) Multi-Projector Servo-Controlled Display System

(75) Inventors: Loïc BECOUARN, Pessac (FR); Johanna DOMINICI, Eysines (FR); Siegfried ROUZES, Le Haillan (FR)

(73) Assignee: THALES, Neuilly-sur-Seine (FR)

(21) Appl. No.: 13/090,227

(22) Filed: Apr. 19, 2011

(30) Foreign Application Priority Data
Apr. 20, 2010 (FR) 10 01666

(51) Int. Cl. G03B 21/14

(52) U.S. Cl. 353/31

(57) ABSTRACT

A display system includes at least two devices for projecting images and a single screen, each projection device including an image source and projection optics arranged so as to project the image delivered by the image source onto a display region of the screen so that the various images projected from various image sources form a single image without obvious discontinuities, said display system having a device for monitoring and servo-controlling the alignment of the various images. The monitoring and servo-control device is such that the image delivered by each image source includes at least one detection pattern so that the projected image of said detection pattern meets the screen in a detection region located outside of the image display region, the screen having a plurality of light sensing elements, each light sensing element being associated with a projection device and placed so that the projected image of a detection pattern delivered by said projection device forms on its light-sensitive surface, the sensing element being arranged so as to determine the position and/or the orientation of said detection pattern and its photometric properties.

### CROSS-REFERENCE TO RELATED APPLICATION

This application claims priority to foreign French patent application No. FR 1001666, filed on Apr. 20, 2010, the disclosure of which is incorporated by reference in its entirety.

### FIELD OF THE INVENTION

The field of the invention is that of projection displays, the continuous image of which is formed by several projectors.

### BACKGROUND

Widescreen displays, the diagonal of which is larger than one metre, are, at the present time, produced using liquid-crystal displays or plasma displays or else projection systems. These displays are designed for fairly large viewing distances, i.e. distances greater than or equal to 2 metres. The use of these types of displays to produce an aircraft instrument panel comprising a single continuous display region is not possible since the viewer is on average about 70 centimetres from said panel. If it is desired for the pixel size to be less than or equal to the resolution limit of the eye, i.e. about 1′ of arc or 0.3 mrad, the pixel size must not exceed about 200 μm. The corresponding resolution for a one-metre wide screen is therefore at least 5000 pixels. This resolution is not currently available in liquid crystal or plasma displays, or in LCD (Liquid Crystal Display), LCoS (Liquid Crystal on Silicon) or DLP® (Digital Light Processing) video projector displays, to mention only the principal technologies.

To achieve this resolution over such substantial dimensions the technical solution consists in using a mosaic of projectors illuminating, from the front or back, a projection screen so that the viewer has the impression that the image is formed by a single projector. Thus, FIG. 1 shows a perspective view of an instrument panel comprising a single display screen E comprising five display zones Z_{A}, each region being illuminated by a dedicated projector P, each projector having adequate resolution. FIG. 2 shows a front view of this projection screen E. The screen is shown by the bold lines. Each display region Z_{A}, shown by the dotted lines, is illuminated by an image I_{P}, delivered by a projector P, of slightly greater size than the display region so that the various images overlap, as may be seen in FIG. 2. The various images I_{P} are shown by the fine lines.

However, this technical solution poses a few problems that must be obviated. The first is alignment of the various projectors P, which must be perfect. This is because, if the images delivered by the various projectors are not correctly aligned, the interface between the images becomes visible and gives the impression of seeing several screens. Furthermore, a continuous transition between two images is generally obtained by a partial superposition of adjacent images. However, if these images are not aligned, the images are confused and become illegible in the regions of overlap. The second problem concerns brightness uniformity. The brightness of all the projectors must be consistent over the entire display surface. A brightness that changes from one projector to another gives the impression of seeing several screens. These two problems can be removed during manufacture of the screen and will not reappear during “indoor” use, i.e. when the device is maintained at a stable ambient temperature of between 15° C. and 25° C., for example in a vibrationless environment, as proposed in U.S. Pat. No. 7,334,901.

But these problems may reappear when the conditions of use become extreme. Thus, when used in an aircraft, vibration at take-off and landing is very intense, sufficiently intense for the position of the projectors, and therefore the alignment of the projected images, to be altered. In addition, substantial temperature differences are encountered, the temperature possibly varying from −40° C. to +55° C., thereby possibly causing the colour, the flux emitted by the light sources and the projection direction of the projectors to visibly change by different amounts, leading to the reappearance of interfaces between the projected images.

It is therefore important to know at any moment the orientation of the projectors and their photometric and colorimetric properties. The technical problem to be solved is therefore to provide:
a first means allowing the alignment of the projectors to be corrected, in real time; and
a second means allowing the brightness uniformity of the projector array and the colour balance to be controlled, also in real time.

U.S. Pat. No. 6,310,650 entitled “Method and apparatus for calibrating a tiled display” and U.S. Pat. No. 6,804,406 entitled “Electronic calibration for seamless tiled display using optical function generator” describe a multi-projector display device, the control device of which comprises a camera, placed on the viewer side, which analyses the images delivered by the various projectors. Apart from the fact that there is a risk that the viewer will move between the camera and the screen and interrupt the measurement, this method requires specific patterns to be displayed. It is useful during manufacture and calibration of the screen in the factory, but does not allow the alignment to be easily controlled in real time.

U.S. Pat. No. 6,362,797 entitled “Apparatus for aligning multiple projected images in cockpit displays” describes a multi-projector display device, the control device of which comprises a camera placed on the projector side. The viewer may no longer move between the camera and the screen. The camera observes the composite image delivered by the projectors and an algorithm calculates, in real time, the corrections required. The effectiveness of this algorithm can be greatly reduced depending on the content of the image displayed. Moreover, image analysis algorithms require very high computational speeds.

### SUMMARY OF THE INVENTION

All these solutions therefore have substantial drawbacks. The device for monitoring and correcting the alignment and the photometric and colorimetric parameters of a multi-projector device according to the invention does not have these drawbacks. It essentially includes positioning patterns of simple shape generated at the edge of the images and linear sensor arrays placed at the edge of the screen. The changes are therefore small relative to a display device without a monitoring device while allowing the problems posed by projector misalignment to be addressed.

More precisely, the subject of the invention is a display system comprising at least two devices for projecting images and a single screen, each projection device comprising an image source and projection optics arranged so as to project the image delivered by the image source onto a display region of the screen having a preset shape and position so that the various images projected from various image sources form a single image without obvious discontinuities, said display system comprising a device for monitoring and servo-controlling the alignment of the various images relative to the preset shapes and positions of the various display regions, characterized in that the image delivered by each image source comprises at least one detection pattern such that the projected image of said detection pattern meets the screen in a detection region located outside of the image display region, the screen comprising a plurality of light sensing elements, each light sensing element being associated with a projection device and placed so that the projected image of a detection pattern delivered by said projection device is formed on its light-sensitive surface, the sensing element being connected to electronic means, arranged so as to determine the position and/or the orientation of said detection pattern and its photometric properties.

In a first embodiment, the light-sensitive sensing elements are monochromatic and the image source emits triplets of images in succession in time, a first image comprising a first pattern of a first colour, a second image comprising a second pattern of a second colour and a third image comprising a third pattern of a third colour.

In a second embodiment, the light-sensitive sensing elements are tri-chromatic and the patterns are “white”.

Preferably, the light sensing elements comprise at least one strip of photodetectors. More precisely, each sensing element comprises two identical strips arranged in a chevron pattern. It is also possible to use matrices of sensing elements.

Advantageously, the detection patterns are zigzag or W-shaped patterns or barcode patterns.

Advantageously, in the normal mode of operation, the patterns are emitted at a given modulation frequency, the electronic means being arranged so as to detect said frequency, the absence of this frequency being characteristic of a frozen image.

Advantageously, at least one first sensing element is placed in the centre of a detection region or at least one second sensing element is placed at the edge of two adjacent detection regions, in a region common to two projected images, so that at least the projected image of a detection pattern of the first image and the projected image of a detection pattern of the second image can form on the light-sensitive surface of said sensing element.

Preferably, the position and orientation of the image delivered by each projection device depend on position and/or orientation data delivered by the associated sensing element and the brightness and the colour of the image depend on photometric data delivered by said associated sensing element.

In a preferred application the system is an aircraft instrument panel.

### BRIEF DESCRIPTION OF THE DRAWINGS

The invention will be better understood and other advantages will appear on reading the following non-limiting description and by virtue of the appended drawings among which:

FIG. 1 shows a perspective view of a multi-projector single-screen display device;

FIG. 2 shows a front view of the screen and the various display regions;

FIG. 3 shows a first embodiment of a detection pattern and its associated sensing element; and

FIG. 4 shows a second exemplary arrangement of the sensing element and the associated detection patterns.

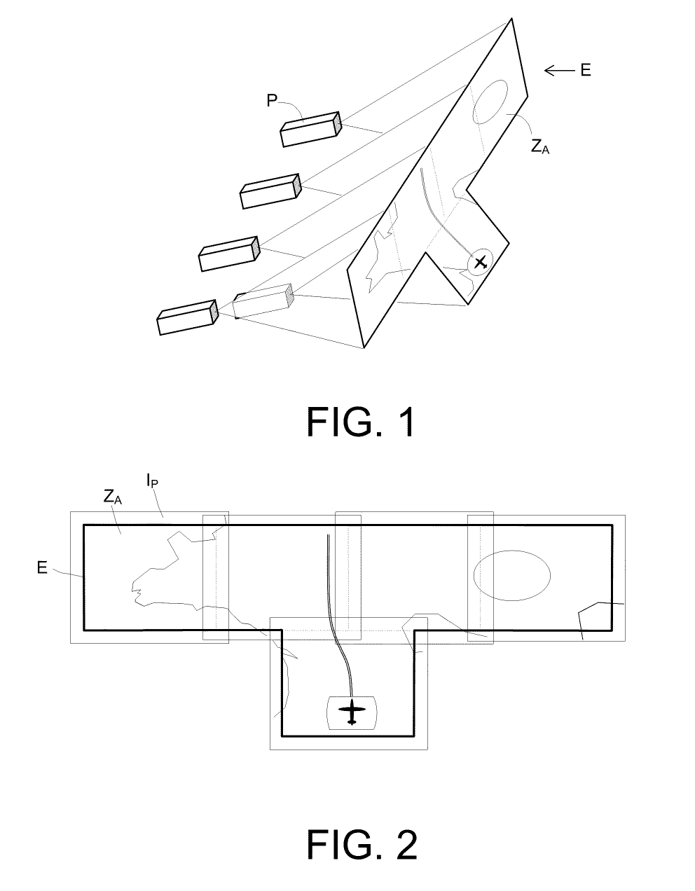

### DETAILED DESCRIPTION

The display system according to the invention comprises a device for monitoring and correcting the alignment and photometric and colorimetric parameters. The latter device essentially comprises systems for detecting the position and/or orientation associated with each image projection device. These systems are also referred to as DDP systems. It is thus possible to precisely determine the position and orientation of each image and, knowing this information, to suitably correct the position or orientation.

There are various types of DDP systems. The detection system according to the invention comprises optical sensing elements judiciously placed around the screen. Each projected image comprises at least one detection pattern such that the projected image of said detection pattern meets the screen in a detection region of an optical sensing element and outside of the display region of the image. Knowing the position and/or the orientation of the detection pattern and its photometric properties, the corrections to be made to the image are calculated therefrom.

It is possible to use matrices of sensing elements to detect the detection patterns. However, it is preferable to use sensing elements formed by strips of light sensing elements, which are well suited to this type of measurement. In this case, the patterns may have various possible shapes. It is notably possible to use patterns in the form of barcodes inclined to suit the orientation of the sensing element.

One detection method is particularly well suited to the device according to the invention. It consists in generating patterns in the form of arrays of rectilinear segments, in detecting quadruplets of points of intersection between said rectilinear segments and one or two light-sensitive strips, in identifying particular cross-ratios between these four points and in determining the orientation and position of the pattern from these cross-ratios. The detection patterns are generally zigzag or W-shaped patterns. It has been shown that, to know the orientation and position parameters simultaneously, it is necessary for the sensing element to comprise two non-collinear strips or two strips placed in a chevron, and for the detection pattern to comprise two patterns. The number of strips may be limited to a single strip if the movement of the image projector is constrained by a mechanical structure.

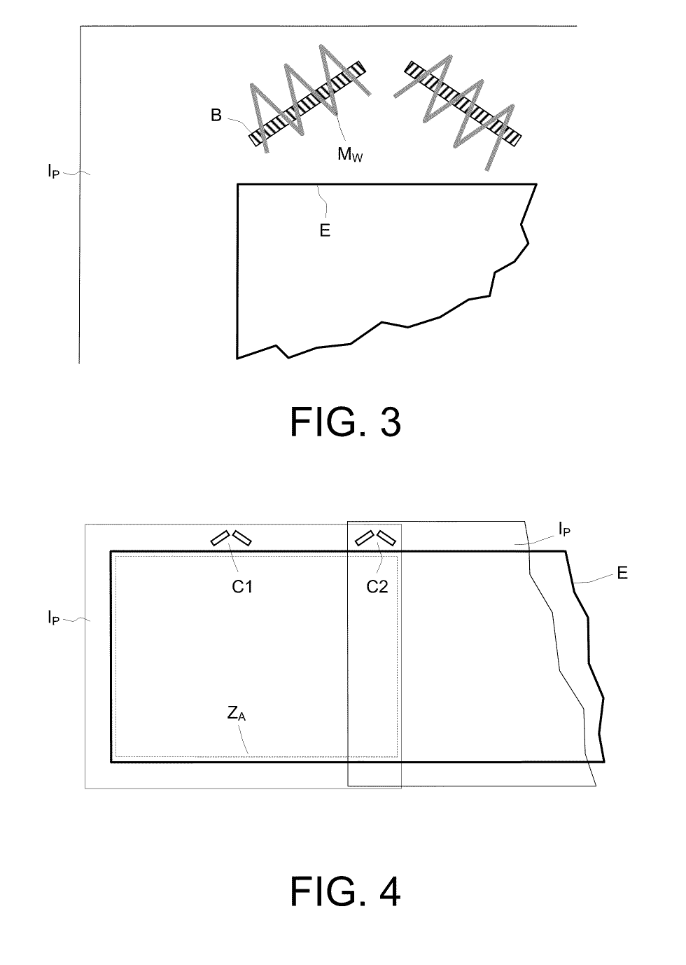

The reader may refer to French patent application FR 2 920 546 of the company Thales entitled “Procédé de detection des extrémités d'un capteur linéaire dans l'espace par projection de mires” (Method for detecting the ends of a linear sensor in space by raster projection) for all technical information concerning this method. FIG. 3 shows the array of two inclined strips B placed in the detection region and the W-shaped detection patterns M_{W}.

The sensing elements must be capable of returning both photometric and colorimetric information about the image. In a first embodiment, the light sensing elements are monochromatic and the image source emits triplets of images in succession in time, a first image comprising a first pattern of a first colour, for example red, a second image comprising a second pattern of a second colour, for example green, and a third image comprising a third pattern of a third colour, for example blue. All that is then required to obtain the desired colorimetric data is to synchronize the means of analysing the data delivered by the sensing elements with the emission of the coloured patterns.

In a second embodiment, the light sensing elements are tri-chromatic and the patterns are “white”. Strips that are sensitive to the primary colours, such as red, green and blue, are then used allowing the brightness uniformity and the colour balance to be servo-controlled using a direct photometric and colorimetric measurement of the projected patterns in real time. These patterns must contain the three primary colours and these patterns are then said to be white.

The sensing elements C are necessarily arranged at the edge of the screen, as may be seen in FIG. 4. There are various possible arrangements. It is possible for the sensing element C1 to be arranged such that it is located in the middle of a dedicated edge of the projected image. It is also possible for the sensing element C2 to be arranged in a detection region common to two adjacent projected images. In this case, it is necessary to discriminate between the patterns coming from the two images. Various techniques may be used. Differently shaped patterns or differently coloured patterns can be generated, it is also possible to offset the patterns in time so that the sensing element receives, at a given moment, one and only one pattern from a defined projected image.

It is not necessary for the projection surface of the screen to be flat. A curved surface the shape of which is known may also be used as a screen.

The sensing element array may be arranged on the edge of the screen in a detection region the width of which does not exceed 20 mm.

Knowing the position and/or orientation data and the photometric and/or colorimetric data delivered by each sensing element, it is easy to determine the position, orientation and the photometric properties of the image delivered by each projection device and to make the necessary corrections if the image moves from its initial position. It should also be noted that if there is a redundancy in the number of sensing elements, it becomes possible to verify not only the position of the image but also the screen deformation.

An initialisation phase may also be carried out in which the various parameters delivered by the sensing elements are recorded when all the images are perfectly adjusted.

It is very simple to use the device according to the invention to detect frozen images. A critical fault monitored in displays for aircraft is frozen images because they may remain unnoticed by the crew for some time. Detection of frozen images requires a complicated surveillance of the drive signals of LCD panels. In the present case, sensing elements are placed in the emitted image. In normal operation, all that is required is for the patterns to be emitted at a given modulation frequency and for electronic means to be arranged to detect said frequency so that the absence of this frequency is characteristic of a frozen image.

This monitoring and servo-control device has several significant advantages. It requires only minor modifications to the screen and the projection devices. These modifications consist in introducing light-sensitive strips on the edge of the screen, in introducing patterns into the parts that cannot be seen of the projected images, in creating a feedback loop for servo-control of the geometric and photometric parameters of the projected images using data delivered by the sensing elements, knowing that, by nature, the corrections required are necessarily small.

The only limitation of this monitoring device is that it is preferable for the projected image to comprise a detection region outside of the display region so that the sensing elements do not create shadows on the screen, thereby possibly limiting the display system to a device comprising two rows of projectors, each row possibly comprising an indeterminate number of projectors. This is amply sufficient to produce an aircraft instrument panel.

1. A display system comprising:
at least two devices for projecting images and a single screen, each projection device comprising an image source and projection optics arranged so as to project the image delivered by the image source onto a display region of the screen having a preset shape and position so that the various images projected from various image sources form a single image without obvious discontinuities, and
a device for monitoring and servo-controlling the alignment of the various images relative to the preset shapes and positions of the various display regions,
wherein the image delivered by each image source comprises at least one detection pattern such that the projected image of said detection pattern meets the screen in a detection region located outside of the image display region, the screen comprising a plurality of light sensing elements, each light sensing element being associated with a projection device and placed so that the projected image of a detection pattern delivered by said projection device forms on its light-sensitive surface, the sensing element being connected to electronic means, arranged so as to determine the position and/or the orientation of said detection pattern and its photometric properties.

2. The display system according to claim 1, wherein the light sensing elements are monochromatic and wherein the image source emits triplets of images in succession in time, a first image comprising a first pattern of a first colour, a second image comprising a second pattern of a second colour and a third image comprising a third pattern of a third colour.

3. The display system according to claim 1, wherein the light sensing elements are tri-chromatic and in that the patterns are “white”.

4. The display system according to claim 1, wherein the light sensing elements further comprise at least one strip of photodetectors.

5. The display system according to claim 4, wherein each sensing element further comprises two identical strips arranged in a chevron pattern.

6. The display system according to claim 4, wherein the detection patterns are zigzag or W-shaped patterns.

7. The display system according to claim 4, wherein the detection patterns are barcode patterns.

8. The display system according to claim 1, wherein the light sensing elements further comprise at least one photodetector matrix.

9. The display system according to claim 1, wherein, in the normal mode of operation, the patterns are emitted at a given modulation frequency, the electronic means being arranged so as to detect said frequency, the absence of this frequency being characteristic of a frozen image.

10. The display system according to claim 1, wherein at least one sensing element is placed in the centre of a detection region.

11. The display system according to claim 1, wherein at least one sensing element is placed at the edge of two adjacent detection regions, in a region common to two projected images, so that at least the projected image of a detection pattern of the first image and the projected image of a detection pattern of the second image can form on the light-sensitive surface of said sensing element.

12. The display system according to claim 1, wherein the position and orientation of the image delivered by each projection device depend on position and/or orientation data delivered by the associated sensing element and in that the brightness and the colour of the image depend on photometric data delivered by said associated sensing element.

13. The display system according to claim 1, wherein the system is an aircraft instrument panel.
